(19) United States
(12) Patent Application Publication
(10) Pub. No.: US 2016/0165976 A1
(43) Pub. Date: Jun. 16, 2016

(54) UTILITY GLOVE WITH INTEGRATED MEASURING DEVICE

(71) Applicant: Anthony Scopelliti, West Harrison, NY (US)

(72) Inventor: Anthony Scopelliti, West Harrison, NY (US)

(21) Appl. No.: 14/565,575

(22) Filed: Dec. 10, 2014

(51) Int. Cl. A41D 19/00; G01B 3/10

(52) U.S. Cl. CPC A41D 19/0027; G01B 3/1071; G01B 2003/1074

(57) ABSTRACT

A utility glove integrally fitted with a selectively retractable tape measure that extends approximately 18 inches to 36 inches. The tape measure is positioned within a compartment located on the dorsal surface of the glove opposite the palm, below the knuckles of the glove index finger and glove middle finger. At the base of the glove index finger, an access aperture is furnished through which a bent tip of the tape measure is exposed. The bent tip of the tape measure is positioned such that it is engaged and extended by the thumb of the same hand on which the glove is positioned without required use of the opposite hand to draw the extendable tape of the selectively retractable tape measure.

### FIELD OF INVENTION

The present application relates generally to a protective glove for laborers. More specifically, the invention relates to a utility glove for use by contractors, mechanics, electricians, plumbers and handymen engaged in renovations, repairs, installations and related tasks. Even more particularly, the invention involves a utility glove fitted with a retractable measuring device adapted for use in the field by a worker having limited hand-mobility and use of hands.

### BACKGROUND OF THE INVENTION

Many workers wear gloves for a variety of reasons in connection with the performance of a variety of assigned tasks. For example, gloves are worn to provide protection to prevent injuries when handling or working with sharp objects. Gloves are also worn to afford a better grip of items being handled by a worker. Moreover, gloves are often warm to increase or maintain warmth of a worker's hands while working outdoors in cold temperatures.

Notwithstanding the utility and practical advantages of wearing gloves, there are disadvantages and inherent dangers associated with many tasks performed by workers who typically utilize gloves. For example, workers who often find themselves suspended on a ladder must typically use their hands to maintain balance and/or hold onto the ladder rungs to avoid falling to the surface below. Simultaneously, in order to perform the assigned tasks while suspended on the ladder, such as taking measurements on the outside of a building, workers must relinquish some security by releasing the rungs used to climb the ladder. Although it may conceivably be safer for workers to hold onto a ladder with at least one hand while taking measurements with the other hand, taking an accurate measurement typically requires use of both hands which are both not available unless that workers wishes to increase the risk of taking a fall.

Other deficiencies associated with typical gloves are evidenced by an apparent lack of active utility in gloves worn by workers who perform repetitive tasks, such as taking frequent measurements. In other words, while gloves generally provide a passive attributes that help workers perform, they are generally not equipped to help users perform tasks beyond those that a worker would be able to perform without the gloves, albeit with greater difficulty. With regard to taking measurements in particular, a worker must typically reach for a measuring device, such as a tape measure worn at the waste of a tool belt and then return the measuring device back in the tool belt for later use. Tape measures that are worn or reside on the waste are often cumbersome to use and easy to lose.

Attempts at solutions to some of these drawbacks and deficiencies are presented in the prior art. For example, U.S. Published Application 2009144881 discloses work gloves with marking indicia in the form of a linear measurement scale that can be aligned to mark off dimensions without removing the gloves from the hand. In addition, U.S. Published Application 2013031696 discloses a glove with calibrated markings and a number of visual reference standards, including measurement markings along the exterior of the index finger and middle finger of the glove. U.S. Published Application 2013263355 discloses a latex glove with measurement scales along the top of the index finger and the thumb of a user to provide approximate measurements to health care workers measuring a wound. Notably, each of the foregoing discloses gloves with measuring indicia disposed on the exterior surfaces thereof. The prior art gloves disclosed herein still require use of both hands to take a measurement. Moreover, since the indicia are imprinted on flexible fabric, latex or other similar materials which are further distorted when the gloves are worn by users with different hand sizes, the ability to take precise measurements utilizing these gloves are severely hampered.

Thus, there is a need for a utility glove which is integrally fitted with a device that can take accurate measurements without having to reach for an externally located measuring device, such as a tape measure disposed at the waste of a user.

### SUMMARY OF THE INVENTION

In view of the deficiencies and drawbacks in the prior art, it is a primary object of the present invention to provide a utility glove with an integrated and retractable measuring device for providing accurate measurements for users wearing the utility glove.

Another object of the present invention is to provide a utility glove with an integrated and retractable measuring device that enables users to take accurate measurements without resorting to an externally located measuring device located on the waste of a user or elsewhere.

Yet another object of the present invention is to provide a utility glove with an integrated and retractable measuring device that enables users wearing the utility glove to take accurate measurements with a single, free hand.

A further object of the present invention is to provide a utility glove with an integrated and retractable measuring device that helps prevent unwanted accidents endured by workers taking measurements while suspended on a ladder or elsewhere above a surface below.

Additional objectives will be apparent from the description of the invention that follows.

In summary, there is provided in a preferred embodiment of the present invention a utility glove integrally fitted with a measuring device, preferably a selectively retractable tape measure that extends approximately 18 to 36 inches. The tape measure comprises a housing or frame that is positioned within a compartment located on the dorsal surface of the glove (i.e., at the back of a hand of a user), most preferably opposite the palm, below the knuckles of the index finger and middle finger. At the base of the index finger, an aperture is furnished through which a bent tip of the tape measure is exposed. The bent tip of the tape measure is positioned such that it is engaged and extended by the thumb of the same hand on which the glove is positioned without required use of the opposite hand to draw the tape measure.

Additional features of the utility glove are described below in more detail.

### BRIEF DESCRIPTIONS OF THE DRAWINGS

The above-described and other advantages and features of the present disclosure will be appreciated and understood by those skilled in the art from the following detailed description and drawings of which

FIG. 1 is a bottom plan and cutaway view of a preferred embodiment of the utility glove with integrated retractable tape measure of the present invention;

FIG. 2 is a top plan view of the utility glove with integrated retractable tape measure taking a measurement;

FIG. 3 is a top plan view of the utility glove with integrated retractable tape measure being engaged at the bent tip by the thumb of a user; and

FIG. 4 is a top plan view of the utility glove with integrated retractable tape measure being further drawn out by the same extending thumb of a user.

### DETAILED DESCRIPTION OF THE INVENTION

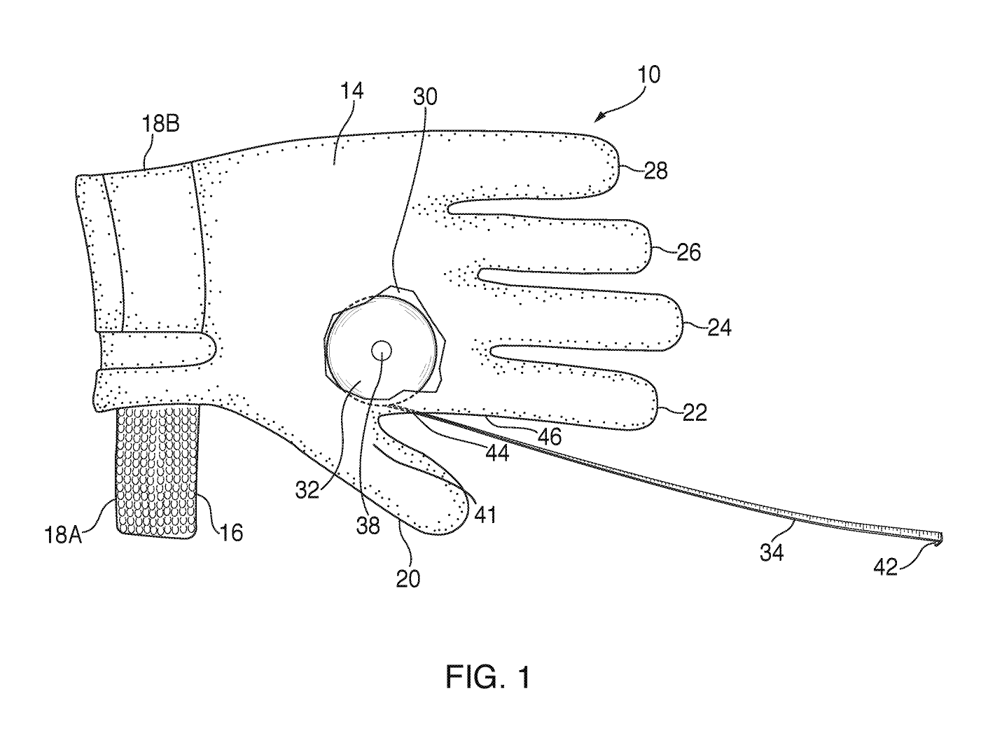

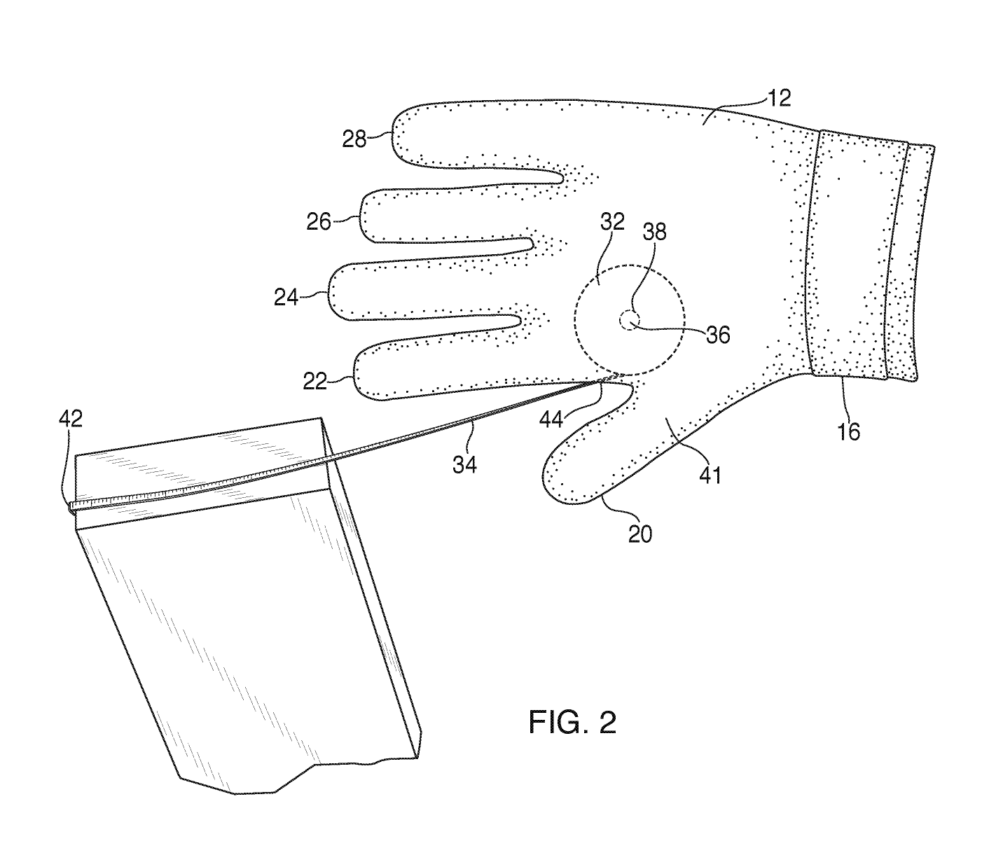

With reference to FIGS. 1 through 4, there is shown a preferred embodiment of the utility glove 10 of the present invention. The utility glove 10 has a top-side dorsal surface 12 that rests against the back of the hand of a user, and a bottom-side palm surface 14 that rests against the palm of a user. In a preferred embodiment utility glove 10 further comprises a closing strap 16 that tightens utility glove 10 at the wrist of a user. Closing strap 16 is fastened via a conventional, hook and loop fastening system 18A, 18B known to those of ordinary skill in the art.

Utility glove 10 comprises a glove thumb 20, glove index finger 22, glove middle finger 24, glove ring finger 26 and glove pinky finger 28. With regard to materials, utility glove 10 may be formed of materials typically utilized in construction of utility gloves including leather (e.g., cowhide, deerhide and sheepskin), rubber, neoprene, cotton, fleece, microfiber, other conventional materials. These and other materials may be utilized alone or in various combinations depending on the specific needs of a user wearing utility glove 10.

Utility glove 10 is fitted with an integrally fitted compartment 30 having an interior area for accommodating a retractable tape measure 32. In a most preferred embodiment, compartment 30 measures approximately two inches in length by two inches in width, with a height of up to one inch and most preferably a half-inch. With regard to the dimensions of the compartment, larger or smaller compartments may be created to accommodate a larger or smaller retractable tape measure 32. Compartment 30 is positioned at the dorsal surface 12 of utility glove 10, beneath the exposed surface of utility glove 10 with compartment 30 positioned between the back of the hand of a user and dorsal surface 12. In that regard, compartment 30 is preferably incorporated as a seamless extension of dorsal surface 12. It should also be appreciated that compartment 30 may be integrally fitted on top of and exterior of dorsal surface 12 forming a small pocket on the dorsal surface 12 of utility glove 10.

Retractable tape measure 32 comprises an extendable tape 34 that is preferably at least 16 inches in length, in the range of 18 inches to 36, and most preferably in the range of 18 inches to 24 inches. Although a longer tape can be utilized, it is desirable for the extendable tape 34 to fit compactly inside compartment 30. Extendable tape 34 is preferably about ¼ inch to ½ inch in width and comprised of a metallic material so that tape 34 is capable of significant extension of at least 16 inches without bending or flexing under its own weight, while still being capable of spooling and retracting into a compact housing fitted inside compartment 30. Preferably, extendable tape 34 is biased to a retracted spooled position. After extendable tape 34 is used, it automatically retracts into compartment 30 after it being released by a user. Optionally, an actuator 36 or other release button may be provided to selectively retract extendable tape 34 after use, allowing the tape 34 to remain extended until actuator 36 is pressed or activated. In that regard, it should be appreciated that actuator 36 may physically extend out from the interior of compartment 30 or at least be subject to sufficient pressure by a user activating or pressing actuator 36 through the dorsal surface 12 of utility glove 10.

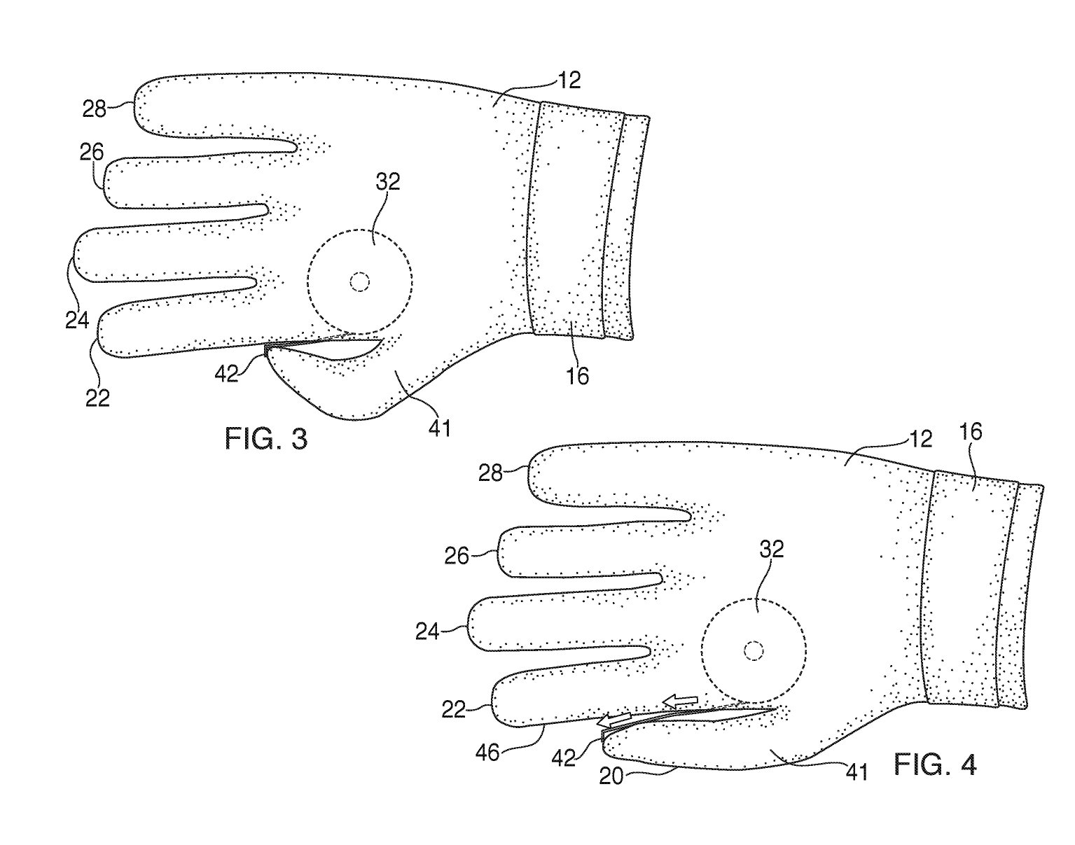

Referring to FIG. 3 and FIG. 4, a utility glove 10 in accordance with the present invention is depicted with a user's hand disposed therein (although not shown). In a most preferred embodiment, retractable measuring tape 32 is positioned adjacent to glove thumb 20, glove index finger 22 and glove middle finger 24 such that the center 38 of retractable tape measure is generally aligned with both the space between glove index finger 22 and glove middle finger 24 and with the base 40 of glove thumb 20 where it meets the body of utility glove 10. In conjunction with the positioning of compartment 30 and retractable tape measure 32, the bent tip 42 of retractable tape measure 32 is positioned so that it projects from a small access aperture 44 located on the interior lateral surface 46 running along said glove index finger 22, at or adjacent to the base 41 of the glove index finger 22. Generally, access aperture is preferably sized to permit the width of the extendable tape 34 to freely side from extended and refracted positions while still preventing bent tip 42 from withdrawing into compartment 30 when not in use. The bent tip 42 and access aperture 44 enables a bent thumb of a user wearing the glove, as shown in FIG. 3, to engage and apply force to the bent tip 42 of the extendable tape 34. As the thumb of a user straightens out, as shown in FIG. 4, the extendable tape 34 is further extended allowing it to be held by a user between the glove thumb 20 and glove index finger 22, without having to resort to the opposite hand that is not wearing utility glove 10. Notably, bent tip 42 should be oriented outwardly, away from the glove index finger 22 and in the direction of glove thumb 20 so that it can be engaged by a user and does not inadvertently injure the user by being forced by a user's thumb (or otherwise) into the index finger.

It should be understood that if larger or more bulky extendable tape and/or tape measure is desired (e.g., greater length, greater width), they may be moved laterally towards the glove ring finger 26 and glove pink finger 28 of the utility glove 10 to provide the needed space. Likewise, in alternate embodiments, the tape measure may be relocated closer to the wrist area and opening of the utility glove 10 if a larger retractable tape measure is utilized. Although the retractable tape measure can be moved, it remains desirable for the tip thereof to be positioned at the access point so that it is engaged by a thumb of a user without having to use the opposite hand to extend the extendable tape.

In a further preferred embodiment of the present invention, the compartment and retractable tape measure is positioned at the palm surface 14 of the utility glove 10. By positioning the tape measure on the palm surface, the motion required by a user's thumb to engage the bent tip may be more natural to the thumb-based movements undertaken on a regular basis.

The accompanying drawings only illustrate a utility glove, its constituent parts, and method of use. However, other types and styles are possible, and the drawings are not intended to be limiting in that regard. Thus, although the description above and accompanying drawings contains much specificity, the details provided should not be construed as limiting the scope of the embodiment(s) but merely as providing illustrations of some of the presently preferred embodiment(s). The drawings and the description are not to be taken as restrictive on the scope of the embodiment(s) and are understood as broad and general teachings in accordance with the present invention. While the present embodiment(s) of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. A protective measuring device, comprising:
a glove having a dorsal surface, a palm surface, a glove thumb and a glove index finger;
a compartment having an interior, said compartment integrated with said glove at said dorsal surface of said glove;
an access aperture positioned at said glove index finger of said glove; and
a retractable tape measure having an extendable tape, said retractable tape measure having a bent tip, wherein said retractable tape measure is positioned in said interior of said compartment;
wherein said compartment and said retractable tape measure are positioned to enable said extendable tape to extend from said compartment and said access aperture by said glove thumb.

2. (canceled)

3. The protective measuring device of claim 1, wherein said bent tip extends from said access aperture when said glove thumb engages said bent tip to draw said retractable tape measure.

4. The protective measuring device of claim 3, wherein said access aperture is positioned at a thumb-facing side of said glove index finger.

5. The protective measuring device of claim 4, wherein said retractable tape measure comprises an actuator that withdraws said extendable tape of said tape measure via said access aperture.

6. The protective measuring device of claim 5, wherein said extendable tape is 18 inches to 36 inches in length.

7. The protective measuring device of claim 6, wherein said extendable tape is 18 inches to 20 inches in length.

8. The protective measuring device of claim 1, wherein said glove thumb comprises a glove thumb base, said protective measuring device further comprising a glove middle finger having a glove middle finger base, wherein said compartment is positioned adjacent to the glove thumb base.

9. The protective measuring device of claim 8, wherein said glove index finger has a glove index finger base, and further wherein said compartment is further positioned adjacent to the glove index finger base and the glove middle finger base.

10. (canceled)

11. The protective measuring device of claim 9, wherein said bent tip extends from said access aperture so that said bent tip is engaged by the glove thumb when said protective measuring device is in use.

12. A protective measuring device, comprising:
a glove having a dorsal surface and a palm surface and a glove thumb;
a compartment having an interior, said compartment integrated with said glove; and
a retractable tape measure having an extendable tape, said retractable tape measure having a bent tip, wherein said retractable tape measure is positioned in said interior of said compartment;
an access aperture from which said bent tip extends and is engaged by said glove thumb when said measuring device is in use;
wherein said compartment and said retractable tape measure are positioned to enable said extendable tape to extend from said compartment by said glove thumb during use of said protective measuring device.

13. The protective measuring device of claim 12, wherein said compartment is integrated at said dorsal surface of said glove.

14. The protective measuring device of claim 12, wherein said compartment is integrated at said palm surface of said glove.

15. (canceled)

16. (canceled)

17. The protective measuring device of claim 12 further comprising a glove index finger, wherein said access aperture is positioned at a position along an interior lateral surface of said glove index finger.

18. The protective measuring device of claim 17 wherein said compartment and said retractable tape measure are positioned adjacent to said glove thumb and said glove index finger.

19. The protective measuring device of claim 18 wherein said extendable tape is of sufficient rigidity to extend at full length without bending.

20. The protective measuring device of claim 19 wherein said extendable tape has a length dimension of at least 16 inches.
